(19) United States
(12) Patent Application Publication
(10) Pub. No.: US 2003/0192435 A1
(43) Pub. Date: Oct. 16, 2003

(54) Cooking appliance

(76) Inventor: John Duncan McNair, Hong Kong (HK)

Correspondence Address: ORUM & ROTH, SUITE 1616, 53 W. JACKSON BLVD, CHICAGO, IL, 60604, US

(21) Appl. No.: 10/120,754

(22) Filed: Apr. 11, 2002

(51) Int. Cl. A23L 1/00; A47J 37/12

(52) U.S. Cl. 99/330; 99/403; 99/409

(57) ABSTRACT

A cooking appliance includes a vessel to receive liquid to be heated, a heater associated with the vessel to heat the liquid, a perforated basket for receiving food to be cooked by immersion in the liquid, and drive motor and threaded shaft for lowering and raising the basket into and out of the liquid as desired. The appliance is particularly suitable for cooking pasta or deep-frying chips.

### BACKGROUND OF THE INVENTION

The present invention relates to cooking appliances. More particularly, though not exclusively, the invention relates to a pasta maker/deep fryer/boiler, having a basket to contain pasta, potato chips or other food, which basket can be automatically lowered into heated water or cooking oil and raised therefrom when needed.

The usual method of cooking pasta is to immerse the pasta in boiling water and then drain the pasta, once cooked, through a separate colander. Rice can be cooked in a similar way. To deep-fry potato chips, the raw potato pieces are placed in a basket and then immersed in heated cooking oil. Once cooking is completed, the basket is raised manually from the cooking oil and suspended for a while or shaken to remove excess oil from the cooked chips.

Sometimes, it might be desirable to lift the food from the boiling water or cooking oil during the cooking process, say for example to see if the food is sufficiently cooked, or in the case of deep-fried chips, to enable the cooking oil to return to a high temperature after water released from the potatos is boiled off as steam and cools the oil to below ideal frying temperature.

### OBJECT OF THE INVENTION

It is an object of the present invention to provide an appliance, which automates the above process.

### DISCLOSURE OF THE INVENTION

There is disclosed herein a cooking appliance comprising:

a vessel to receive liquid to be heated,

a heater associated with the vessel to heat the liquid.

a perforated basket for receiving food to be cooked by immersion in the liquid, and

drive means for lowering and raising the basket into and out of the liquid as desired.

Preferably the vessel and basket are circular when viewed from above.

Alternatively, the vessel can be rectangular.

Preferably the drive means includes a threaded shaft extending vertically and adapted to rotate about a longitudinal axis thereof, and the basket has a nut affixed thereto and engaging with the threaded shaft. As an option, the nut could be replaced with a threaded shaft and the shaft could be replaced with a nut.

Preferably the threaded shaft extends through a vertical tube forming part of the vessel at the centre thereof, which tube extends to a position above the intended liquid level.

Preferably the basket includes a key that slides within a vertical slot that is provided in the vessel to prevent unwanted spinning of the basket as it is raised or lowered by the drive means.

Preferably the key is positioned to be released from the slot when the basket is raised or lowered beyond a certain level to enable the basket to be spun to assist drainage of liquid therefrom centrifugally, or in the lower disengaged position, to agitate the basket whilst immersed.

Preferably there is a feature at an upper and/or lower end of the shaft for locking the nut to the shaft to cause the basket to spin with the shaft.

Preferably the drive means further includes a motor and a gear train by which output of the motor is transmitted to the shaft.

Preferably the vessel is lidded.

Preferably the appliance includes a steam switch to activate the drive means or start the cooking process.

Preferably the steam switch is positioned beneath the vessel and the vessel includes a longitudinal steam tube extending from a position above the liquid in the vessel to a position adjacent to the steam switch.

Preferably the motor, gear train and steam switch are situated within a base that supports the vessel.

Preferably there is associated with the drive means a control circuit that is programmed to provide desired movement of the basket, depending upon the type of food being cooked by the appliance and any feedback signals from the steam switch, a thermostat or a position sensor on the drive means or basket.

### BRIEF DESCRIPTION OF THE DRAWINGS

A preferred form of the present invention will now be described by way of example with reference to the accompanying drawings, wherein:

FIG. 1 is a schematic cross-sectional elevational view of a food cooking appliance having it's food suspension basket positioned above liquid in it's vessel,

FIG. 2 is a schematic cross-sectional elevational view of the food cooking appliance of FIG. 1 with the food suspension basket immersed in the liquid,

FIG. 3 is a schematic cross-sectional elevational view of another food cooking appliance having it's food suspension basket positioned above liquid in it's vessel,

FIG. 4 is a schematic cross-sectional elevational view of the food cooking appliance of FIG. 3 with the food suspension basket immersed in the liquid, and

FIG. 5 is a schematic plan view of the food cooking appliance of FIGS. 3 and 4.

### DESCRIPTION OF THE PREFERRED EMBODIMENTS

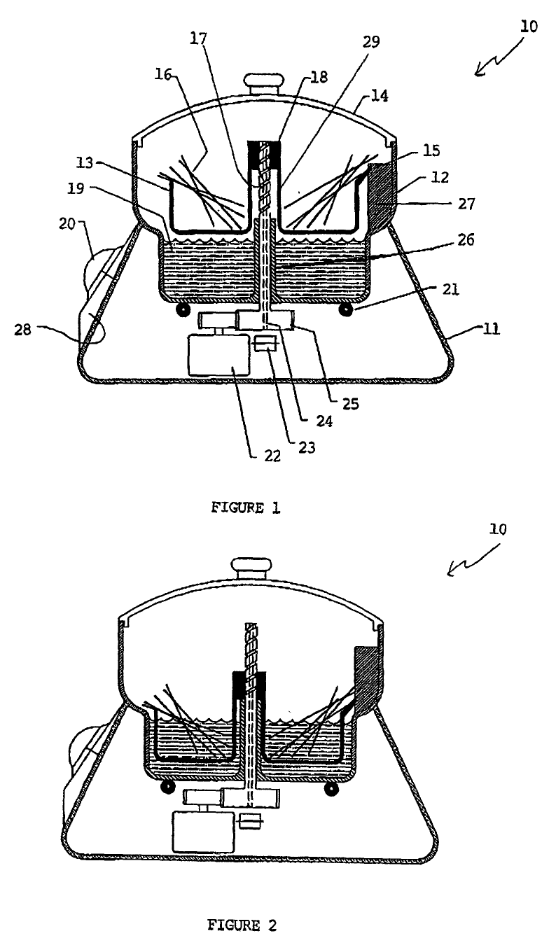

In FIGS. 1 and 2 of the accompanying drawings are there is schematically depicted a cooking appliances 10. The appliance 10 includes a base 11 supporting a vessel 12. The base 11 might be formed of plastics, ceramic or metallic material for example, whereas the vessel 12 might be formed of aluminium, stainless steel, ceramic or other heat-resistant waterproof material. Covering the vessel 12 is a lid 14 that would typically be formed of glass, polycarbonate or other heat resistant material that is preferably see-through or transparent.

Preferably, the vessel 12 includes a narrow bottom portion and a wider top portion as shown in the drawings. At the centre of the vessel 12, there is provided a tube 26 through which a non-threaded portion of a screw threaded shaft 17 extends vertically. Supported by the shaft 17 is a perforated basket 13, typically formed of fine stainless steel mesh. Alternatively, the basket could be formed of stainless steel sheet or other suitable material having fine holes drilled, pressed or otherwise formed therethrough.

The basket 13 includes a central hollow portion or tube 29 having a nut 18 a fixed internally. The internal thread of the nut 18 engages with the threaded portion of the shaft 17.

A key 15 extends from an edge of the basket 13 into a vertical key slot 27 formed or attached to the inside surface of the wider portion of the vessel 12. The key slot 27 might be formed in a plastic's moulding for example that is attached to the inside surface of the vessel 12, or might be formed directly on the inside surface of the vessel itself.

Affixed to the bottom of the shaft 17 is a gear, forming part of a gear train 25, another gear of which is attached to the output shaft of an electric motor 22 that is situated within the base 11. An electric heating element 21 is attached to the bottom of the vessel 12 and is controlled by a controller knob 20 situated on the outside of the base 11.

The vessel includes a centrally located, vertically extending steam tube 24 (preferably extending through the shaft 17), the bottom end of which is presented to a steam switch 23. Steam switch 23 is associated with a control circuit positioned at 28 for example. A thermister or a thermostat might alternatively substitute the steam switch.

The bottom or narrow portion of the cooking vessel 12 can be filled with water or cooking oil 19. When the water or oil is at the correct temperature, the controller activates the motor 22 and the gear train 25 effects rotation of the shaft 17. As a result of the interaction between the nut 18 and the threaded portion of the shaft 17, and may be also the interaction of the key 15 with key slot 27, the basket 13 is lowered into the liquid 19 and cooking commences. At a predetermined time, or after detection of a predetermined temperature or pressure of steam, the motor 22 can be reversed to thereby raise the basket 13 out of the liquid 19. The cycle can be repeated for certain foods.

During the cooking process, the basket 13 can be agitated by repeated reversals of the motor 22 for example. Also, in order to provide even cooking, the basket might be rotated when it is immersed in the liquid 19. To this end, the nut 18 might simply come to a position of the shaft 17 where the thread runs out and the shaft is further rotated by the motor.

Further, if the top portion of the shaft 17 is provided with an appropriate formation (such as a non-threaded portion or a fixed lock-nut for example), the basket can be spun when it is at its raised position to thereby drain liquid centrifugally from the cooked food items. If the top portion of the shaft simply ran out of thread and were provided with a small non-threaded portion, continued rotation of the shaft would result in quick vertical agitation of the basket as the thread of nut skips over the end of the thread of the shaft, effectively jolting and shaking the basket on each revolution.

Reversal of the motor 22 can be pre-programmed, controlled manually or result from the provision of a synchronous motor that reverses upon sensing overload.

Possible uses of the appliance are to boil pasta, vegetables, noodles, or rice for example. The appliance might also be used for deep frying chicken, fish, chips or for making Tempura.

There are many possible alternatives in the operational cycle of the appliance. In a first alternative, the appliance could be used to make pasta. The process steps might be as follows:

A. Basket is up

B. Add pasta

C. Punch in start time and/or

D. Punch in cooking time

Press “Start” (if “C” delay; if “D” start)

F. Unit will start clock “D”; or Switch element ON “C”

G. Water boils

H. Unit detects and lowers basket

I. Unit re-boils and starts timer

J. After cooking unit lifts basket and shakes to remove excess water

K. Element continues to warm it required

In an alternative operation as a pasta maker, the process steps might be as follows:

A. Basket is up

B. Add pasta

C. Punch in start time and/or

D. Punch in cooking time

E. Press “start” (it “C” delay; if “D” start)

F. Unit will start clock “D”; or switch element ON “C”

G. Water boils

H. Unit detects and lowers basket

I. Unit re-boils and starts timer and gently spins back and forth to prevent sticking

J. After cooking, unit lifts basket and shakes and spins excess water

K. Element continues to warm if required

L. Food may be returned to water for a short time to reheat if desired

As a deep fryer, the appliance might be used as follows:

A. Basket is up

B. Add chips (or other food)

C. Punch in time (no delay, no spoiling)

D. Oil heats up

E. Unit detects and lowers basket element on full heat

F. Cool oil is detected

G. Basket is lifted and may shake, timer stops

H. Oil re-heats

I. Basket lowers, timers starts

J. Basket raises and shakes, timer stops

Another possible operation of the appliance as a deep fryer is as follows:

A. Basket is up

B. Add chips (or other food)

C. Punch in time (no delay, no spoiling)

D. Oil heats up

E. Unit detects and lowers basked—elements on full heat

F. Cool oil is detected

G. After cooking unit lifts basket and shakes, timer stops

H. Oil re-heats

I. Basket lowers, timer starts

J. Basket gently spins back and forth to tumble the chips

K. Basket raises and shakes, timer stops

L. Basket is spun to remove excess oil

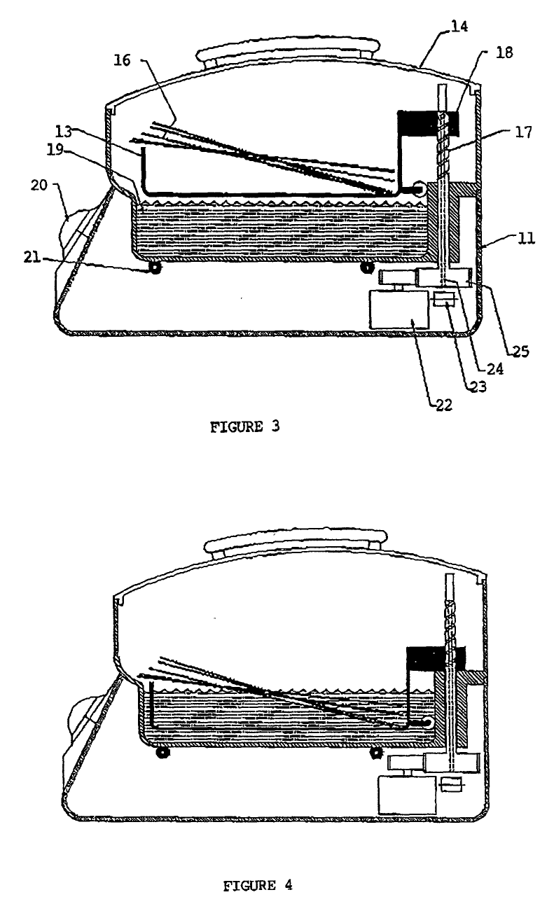

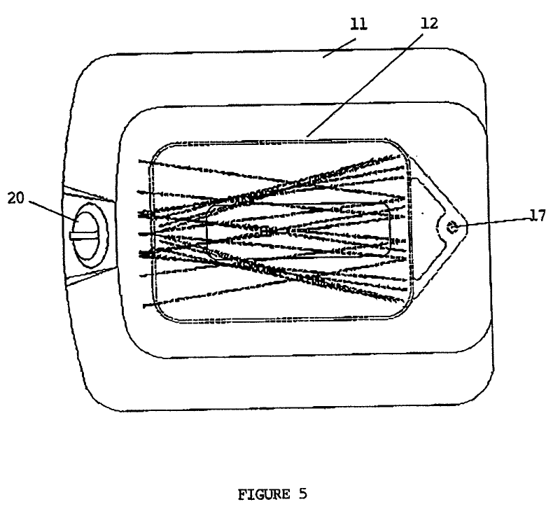

It should be appreciated that modifications and alternations obvious to those skilled in the art are not to be considered as beyond the scope of the present invention. For example, and with reference to FIGS. 3 to 5, the appliance could be made of substantially rectangular shape when viewed from above. In the depicted embodiment, the threaded shaft does not extend through the center of the vessel or the cooking basket via the threaded shaft, but adjacent to one edge thereof so as to suspend the basket in a cantilever fashion.

In general, it should be noted that the device could be used as a multi-purpose device or may be configured to do only one task. However, in the rectangular embodiment depicted, centrifugal spinning of the basket would not take place. Instead, it could be shaken up and down, an action also appictable as an optional supplementary function in with the circular embodiment.

In the rectangular embodiment, the key and keyway may not be necessary, due to the basket shape.

Furthermore, the key may be electrically or mechanically controlled in order to prevent spinning of the circular basket in the embodiment of FIGS. 1 and 2. Also, the key might be mechanically or electrically retractable posted, engaging the basket either from the side, from beneath or from above.

Also, for a deep frying version, the steam switch could be replaced by a thermostat fitted directly to the reservoir base or side. Also, it is not necessary in the circular embodiment of FIGS. 1 and 2 that the reservoir be the stepped as illustrated.

Also, the screw/nut could be a single or multi-start configuration depending on the action that is required.

Furthermore, the heater might be an immersion style, either as a removable or fixed component rather than being permanently fixed to the under-side of the vessel.

And, the perforated basket might be formed of woven wire instead of a sheet having fine penetrations.

1. A cooking appliance comprising:
a vessel to receive liquid to be heated,
a heater associated with the vessel to heat the liquid,
a perforated basket for receiving food to be cooked by immersion in the liquid, and
drive means for lowering and raising the basket into and out of the liquid as desired.

2. The cooking appliance of claim 1, wherein the vessel and basket are circular when viewed from above.

3. The cooking appliance of claim 1, wherein the vessel and basket are substantially rectangular when viewed from above.

4. The cooking appliance of claim 1, wherein the drive means includes a threaded shaft extending vertically and adapted to rotate about a longitudinal axis thereof, and the basket has a nut affixed thereto and engaging with the threaded shaft.

5. The cooking appliance of claim 1, wherein the drive means includes a nut oriented vertically and adapted to rotate about its axis, and the basket has a vertical shaft affixed thereto and engaging with the nut.

6. The cooking appliance of claim 4, wherein the threaded shaft extends through a vertical tube forming part of the vessel at the centre thereof, which tube extends to a position above the intended liquid level.

7. The cooking appliance of claim 1, wherein the basket includes a key that slides within a vertical slot that is provided in the vessel to prevent unwanted spinning of the basket as it is raised or lowered by the drive means.

8. The cooking appliance of claim 7, wherein the key is positioned to be released from the slot when the basket is raised or lowered beyond a certain level to enable the basket to be spun to assist drainage of liquid therefrom centrifugally, or in the lower disengaged position, to agitate the basket whilst immersed.

9. The cooking appliance of claim 4, including a feature at an upper and/or lower end of the shaft for locking the nut to the shaft to cause the basket to spin with the shaft.

10. The cooking appliance of claim 4, wherein the drive means further includes a motor and a gear train by which output of the motor is transmitted to the shaft.

11. The cooking appliance of claim 1, wherein the vessel is lidded.

12. The cooking appliance of claim 11, including a steam switch to activate the drive means, or start a cooking process.

13. The cooking appliance of claim 12, wherein the steam switch is positioned beneath the vessel and the shaft includes a longitudinal steam tube extending from a position above the liquid in the vessel to a position adjacent to the steam switch.

14. The cooking appliance of claim 12, wherein the steam switch are situated within a base that supports the vessel.

15. The cooking appliance of claim 12, wherein there is associated with the drive means a control circuit that is programmed to provide desired movement of the basket, depending upon the type of food being cooked by the appliance and any feedback signals from the steam switch/temperature sensor or other sensor or a timer.
